(19) United States
(12) Patent Application Publication
(10) Pub. No.: US 2019/0394484 A1
(43) Pub. Date: Dec. 26, 2019

(54) METHOD AND APPARATUS FOR PREDICTIVE CODING OF 360-DEGREE VIDEO DOMINATED BY CAMERA MOTION

(71) Applicant: The Regents of the University of California, Oakland, CA (US)

(72) Inventors: Kenneth Rose, Ojai, CA (US); Tejaswi Nanjundaswamy, Goleta, CA (US); Bharath Vishwanath, Santa Barbara, CA (US)

(73) Assignee: The Regents of the University of California, Oakland, CA (US)

(21) Appl. No.: 16/447,554

(22) Filed: Jun. 20, 2019

Related U.S. Application Data
(60) Provisional application No. 62/688,771, filed on Jun. 22, 2018.

(51) Int. Cl. H04N 19/52; H04N 19/597; H04N 19/523; H04N 19/105; H04N 19/537

(52) U.S. Cl. CPC H04N 19/52; H04N 19/597; H04N 19/537; H04N 19/105; H04N 19/523

(57) ABSTRACT

A method and apparatus for predictive coding of spherical or 360-degree video with dynamics dominated by camera motion. To achieve efficient compression, a geodesic translation motion model is introduced to characterize the perceived motion of objects on the sphere. Pixels in the surrounding objects are perceived as translating on the sphere along their respective geodesics, which intersect at the two points where a line, determined by the motions of the camera and surrounding objects, intersects the sphere. This motion compensation perfectly models the perceived motion on the sphere, and accounts for perspective distortions due to camera and object motions. Experimental results demonstrate that the preferred embodiments of the present invention achieve significant performance gains over prevalent motion-compensated prediction techniques, across various projection geometries.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 62/688,771, filed on Jun. 22, 2018, by Kenneth Rose, Tejaswi Nanjundaswamy, and Bharath Vishwanath, entitled “Method and Apparatus for Predictive Coding of 360-degree Video Dominated by Camera Motion,” attorneys' docket number 30794.0687USP1.

### BACKGROUND OF THE INVENTION

### 1. Field of the Invention

This invention relates to a method and apparatus for predictive coding of 360-degree video signals.

### 2. Description of the Related Art

(Note: This application references several different publications as indicated throughout the specification by one or more reference numbers within brackets, e.g., [x]. A list of these different publications ordered according to these reference numbers can be found below in the section entitled “References.” Each of these publications is incorporated by reference herein.)

The spherical video signal, or 360° (360-degree) video signal, is video captured by omnidirectional or multiple cameras, comprising visual information on a sphere that encloses the viewer. This enables the user to view in any desired direction. Spherical video is emerging as the next important multimedia format, revolutionizing different areas including social media, gaming, business, health and education as well as numerous other virtual reality and augmented reality applications. In many applications such as robotics, navigation systems, entertainment, gaming, the dominant component of the motion in the spherical video is due to camera motion, and often specifically camera translation. Spherical video dominated by camera motion is often the application scenario envisioned by large-scale multimedia distributors such as Google™/YouTube™ and Facebook™; 360° video-based game developers such as Microsoft™ and Facebook™; and other broadcast providers such as ESPN™ and BBC™. Given the significance of these applications, there is considerable need for compression tools tailored to this scenario.

With increased field of view, 360° video applications require acquisition at higher resolution compared to standard 2D video applications. Given the enormous amount of data consumed by spherical video, practical applications critically depends on powerful compression algorithms that are tailored to this signal characteristics. In the absence of codecs that are tailored to spherical video, prevalent approaches simply project the spherical video onto a plane or set of planes via a projection format such as Equirectangular Projection [1], or Equiangular Cubemap Projection [2], and then use standard video codecs to compress the projected video. A key observation is that a uniform sampling in the projected domain induces a varying sampling density on the sphere, which further varies across different projection formats. A brief review of some popular projection formats is provided next:

Equirectangular Projection (ERP): This format is obtained by taking the latitude and longitude coordinates of a point on the sphere as its 2D Cartesian coordinates on the plane. The ERP projection is illustrated in FIGS. 1(a)-1(b). FIG. 1(a) depicts the sphere, wherein X, Y and Z are the Cartesian coordinates of the 3-dimensional space, θ is the polar angle, φ is the azimuthal angle, A0-A6 enumerate latitudes (corresponding to distinct polar angles), L0-L6 enumerate longitudes (corresponding to distinct azimuthal angles) and p is an example point on the sphere at latitude A1 and longitude L4. FIG. 1(b) illustrates the point p after projection by ERP onto the plane whose cartesian coordinates are denoted u and v. It is important to note the warping effects, for example, objects near the pole are stretched dramatically when projected by ERP.

Cubemap Projection: In standard cubemap projection, points are radially projected onto faces of a cube enclosing the sphere as illustrated in FIG. 2, wherein X, Y and Z are the Cartesian coordinates of the 3-dimensional space and p is an example point. The six faces are then unfolded onto a single plane. Standard cubemap samples the plane uniformly thus inducing a non-uniform sampling pattern on the sphere. A recent variation on this projection is Equiangular Cubemap (EAC), where the sampling of the projected plane is designed to induce uniform sampling on the sphere.

The Joint Video Exploration Team (JVET) document [3] provides a more detailed description of these formats including procedures to map back and forth between the sphere and the plane for each projection format.

Modern video coders such as H.264 [4] and HEVC [5] use motion compensated prediction or “inter-prediction” to exploit temporal redundancies resulting in significant compression gains. Standard video codecs use a (piecewise) translational motion model for inter prediction, while some nonstandard approaches considered extensions to affine motion models that may be able to handle more complex motion, at a potentially significant cost in side-information (see recent approaches in [6, 7]). Still, in 360° video, the amount of warping induced by the projection varies for different regions of the sphere. This results in complex non-linear motion of objects in projected video in the current scenario involving camera translation, for which both the translation motion model and its affine motion extension are ineffective. Moreover, motion vector in the projected domain doesn't have any meaningful physical interpretation. Thus, a new motion compensated prediction technique that is tailored to the setting of 360° video signals with camera translation is needed.

Notable attempts to meet the challenges in motion compensation for spherical video, include:

Translation in 3D space: Li et al., proposed a 3D translational motion model for the cubemap projection [8]. In this approach, both centers of the current coding block and the reference block are mapped to the sphere, and the 3D displacement between these two vectors is calculated. The remaining pixels in the current coding block are then also mapped to the sphere and all are translated by the 3D displacement vector calculated for the centers. However, after displacement, only the block center is guaranteed to be on the sphere, which necessitates an additional step of projecting the displaced pixels onto the sphere, which in turn causes distortion. This method does not exploit properties of perceived motion on the sphere due to camera motion.

Rotation on the sphere: Vishwanath et al, introduced a rotation motion model for spherical video in [9]. A block of pixels on the projected plane is mapped back to the sphere. The block is then rotated on the sphere about a specified axis, and mapped back to the reference frame in the projected domain. Since rotation is a unitary operation, it preserves the shape and size of the object on the sphere. This approach significantly outperforms its predecessors, but still does not account for the nature of the perceived motion on the sphere due to camera translation.

Tosic et al., propose in [10] a multi-resolution motion estimation algorithm to match omnidirectional images, while operating on the sphere. However, their motion model is largely equivalent to operating in the ERP projected domain, and suffers from the suboptimalities associated with this projection.

A closely related problem is that of motion-compensated prediction in video captured with fish-eye cameras, where the projection to a plane also causes significant warping. Interesting approaches have been proposed to address this problem in [11, 12], but these do not apply to motion under different projection geometries for 360° videos.

The method in [13] processes the motion side information produced by a standard codec operating on video after projection by ERP, to identify two static (low motion) regions that are antipodal on the sphere. It then rotates the sphere so as to align the polar axis with these static regions and re-performs coding using ERP for the new orientation. This method is restricted to ERP. Moreover, it does not attempt to exploit properties of camera motion and is hence suboptimal for the problem at hand. It was shown to offer benefits, but for a small subset of the tested video sequences.

The suboptimal motion compensation procedures employed by the standard approach and other recent approaches, and specifically the inability to fully exploit the properties of perceived motion on the sphere due to camera motion, strongly motivate the present invention whose objectives are to devise and exploit new and effective motion models tailored to the critical needs of spherical video coding dominated by camera motion.

### SUMMARY OF THE INVENTION

The present invention provides an effective solution for motion estimation and compensation to enable substantially better compression of spherical videos dominated by camera motion. Standard video coders perform motion compensated prediction in the projected domain and suffer from considerable suboptimality. Other state of the art technologies fail to exploit the nature of motion perceived on sphere which is due to camera motion. The invention introduces appropriately designed geodesic translation of pixels on the sphere, which captures the perceived motion of objects on sphere due to either pure camera motion or combined camera and object motion. The invention builds on the realization that, given camera and object motions, an object's pixels are perceived to move on the sphere along certain geodesics which all intersect at the point where a line determined by the camera and object velocity vectors intersects the sphere. Preferred embodiments of the invention comprise calculation of the optimal line (determined by camera and object motion) and thereby identification of the geodesics along which object pixels are expected to translate on the sphere. In one embodiment, this line is chosen to lie along the camera velocity vector. In another embodiment it is chosen to lie along a vector obtained by subtracting an object's velocity vector from the velocity vector of the camera. The video codec's motion vectors, in a preferred embodiment of the present invention, specify the amount of translation to apply to pixels along their geodesics. It is important to note that camera or object translation causes perspective distortions. For example, with decrease in the distance between object and camera, the object appears to grow larger. The invention, with its geodesic motion model on the sphere, perfectly accounts for these perspective distortions. Moreover, in the case of pure camera motion with stationary surroundings, there is a unique set of geodesics along which pixels can move, as determined by the camera velocity vector, and the video codec only requires 1D motion vectors to specify block motion to the decoder, resulting in significant bit-rate savings in side-information. An additional significant benefit is that the invention performs motion compensation on the sphere, regardless of the projection geometry in use, which makes it universally applicable to all current projection geometries, as well as any that may be discovered in the future. Experimental results demonstrate that the preferred embodiments of the invention achieve considerable performance gains over prevalent motion models, across different projection geometries and a variety of spherical video sequences.

The present invention provides an apparatus and method for processing a multimedia data stream, comprising: a codec for processing a multimedia data stream comprised of a plurality of frames, wherein the codec comprises an encoder, a decoder, or both an encoder and a decoder; the encoder processes the multimedia data stream to generate encoded data and the decoder processes the encoded data to reconstruct the multimedia data stream; the multimedia data stream contains a spherical video signal with dominant camera translation; and the encoder or the decoder comprises a motion-compensated predictor, which predicts a portion of a current frame from a corresponding portion of one or more reference frames, after motion compensation; and the motion compensation comprises translating the pixels along geodesics on the sphere, where the geodesics are the shortest paths on the sphere from the pixels to the two points where the sphere is intersected by a line determined by the motion of the camera and surrounding objects.

In one embodiment of the present invention, the line determined by the motion of the camera and surrounding objects is along the velocity vector of the camera.

In another embodiment, the line determined by the motion of the camera and surrounding objects is along a vector obtained by subtracting the velocity vector of a surrounding object from the velocity vector of the camera.

The line determined by the motion of the camera and surrounding objects varies from one portion of the current frame to another portion of the current frame.

The motion compensated further comprises rotation of the pixels about an axis.

In one embodiment of the present invention, the axis coincides with the line determined by the motion of the camera and surrounding objects.

In another embodiment of the present invention, the axis coincides with the axis of rotation of the camera.

The motion-compensated predictor further performs interpolation in the one or more reference frames to enable motion compensation at a sub-pixel resolution.

The encoded data comprises information, which specifies for a portion of the current frame, the amount of translation of pixels along the geodesics on the sphere.

### BRIEF DESCRIPTION OF THE DRAWINGS

Referring now to the drawings in which like reference numbers represent corresponding parts throughout:

FIGS. 1(a) and 1(b) illustrate the equirectangular projection (ERP) format, wherein FIG. 1(a) depicts a point on the sphere and FIG. 1(b) depicts its projection onto the plane.

FIG. 2 illustrates the cubemap projection from a sphere to six planes.

FIG. 3 illustrates the perceived motion of objects on the sphere due to camera and object translation.

FIGS. 4(a), 4(b), 4(c), 4(d), 4(e), 4(f) and 4(g) illustrate various motion compensation steps employed in one or more embodiments of the present invention, wherein FIG. 4(a) depicts a block in a current ERP frame; FIG. 4(b) depicts the line with respect to which geodesics are defined for the case of camera motion but static objects; FIG. 4(c) depicts the line with respect to which geodesics are defined for the case of both camera and object motion; FIG. 4(d) depicts the block of FIG. 4(a) after mapping back to the sphere, together with example geodesics along which pixels translate; FIG. 4(e) depicts geodesic translation of the block on the sphere; 4(f) depicts block rotation about an axis; and FIG. 4(g) depicts the motion-compensated block after mapping back to the ERP domain.

FIG. 5 is a schematic diagram illustrating an exemplary embodiment of a multimedia coding/decoding (codec) system that can be used for transmission/reception or storage/retrieval of a multimedia data stream according to one embodiment of the present invention.

FIG. 6 is an exemplary hardware and software environment used to implement one or more embodiments of the invention.

FIG. 7 illustrates the logical flow for processing a multimedia signal in accordance with one or more embodiments of the invention.

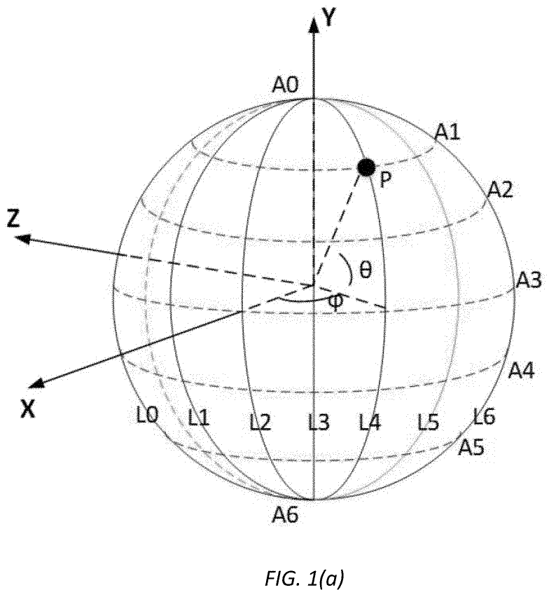

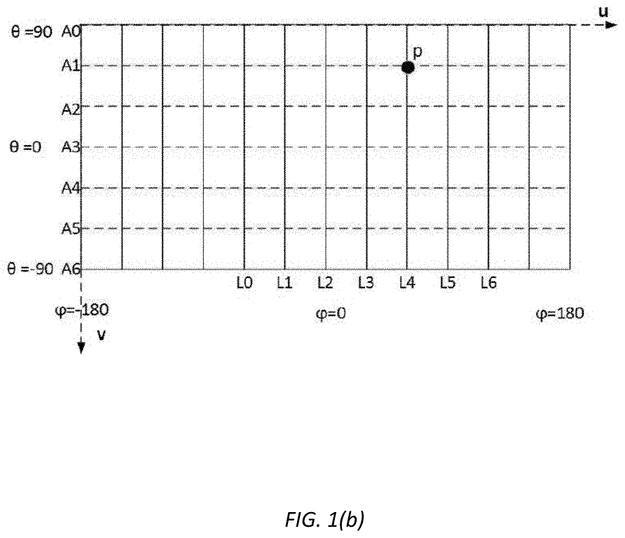

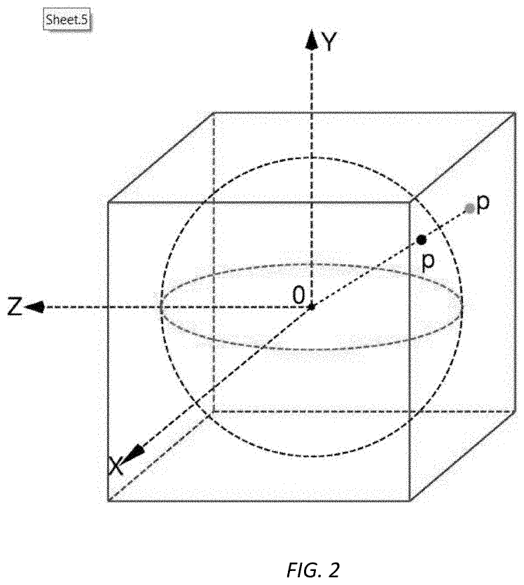

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

Overview

The practicality of many virtual reality applications involving spherical videos with camera motion critically depends on efficient compression techniques for this scenario. In this invention, the nature of perceived motion of objects on sphere due to camera motion is carefully analyzed and exploited for effective compression. The present invention defines a geodesic translation model to characterize motion of objects on the sphere. The analysis shows that an object is perceived to move along geodesics that all intersect at the point where a line determined by the camera and object velocity vectors intersects the sphere. The preferred embodiment of an encoder according to the present invention thus finds this line that is determined by the camera and object velocity vectors, identifies the geodesics representing the shortest path on the sphere between an object pixel and the points where the line intersects the sphere, and signals to the decoder the amount of translation of a block along these geodesics. Motion compensation, according to the present invention, operates completely on the sphere and is thus agnostic of the projection geometry and is hence applicable to any projection formats.

Embodiments of the present invention have been evaluated after incorporation within existing coding platforms, such as HEVC. Experimental results show considerable gains, and provide strong evidence for its effectiveness.

Technical Description

Illustration of Perceived Motion of Objects on the Sphere:

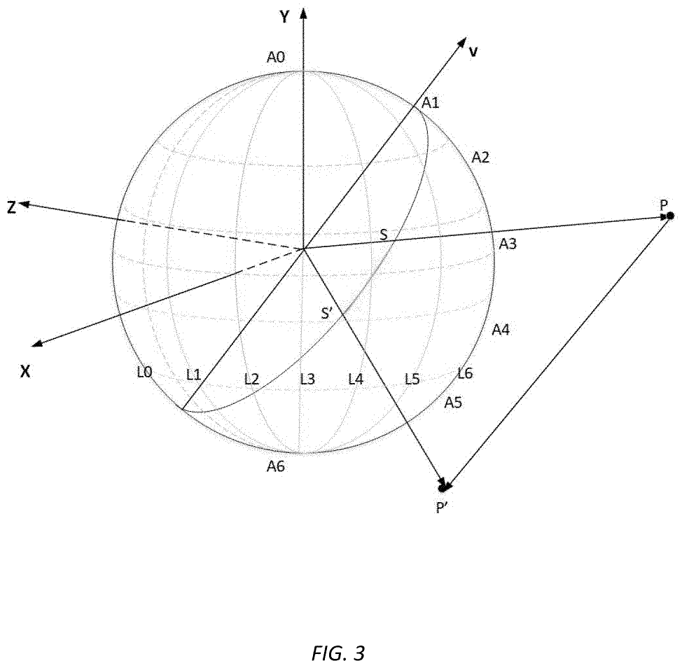

Consider a simple case in which a viewer is at the origin, enclosed by a sphere as shown in FIG. 3. The viewer sees a point P in the environment through its projection point S on the sphere. Due to camera motion, as well as motion of the object containing P, the point P is perceived as displaced to point P′, relative to the viewer. Clearly, its corresponding projection on the sphere traverses along S-S′. Let vector ‘v’ be a vector parallel to the line PP′. In this scenario, v may represent the camera velocity relative to the object, i.e., it can be obtained by subtracting the object velocity vector from the camera velocity vector. Now, the arc S-S′ is a part of the geodesic that connects the two points where a line along vector ‘v’ intersects the sphere. Thus, a critical observation motivating the present invention is that, given the translational motion of camera and object, all pixels in the object are perceived as moving on the sphere along their respective geodesics, which all intersect at the two points determined by the velocity vectors of the camera and the object.

### 1. Prediction Framework with Geodesic Translation Motion Model

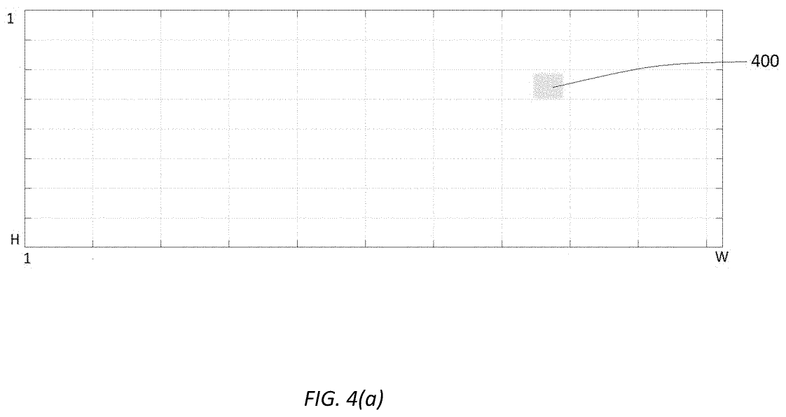

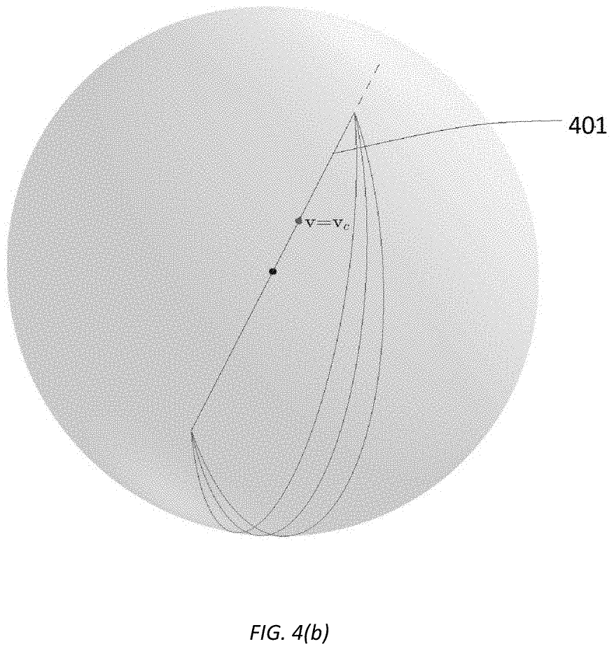

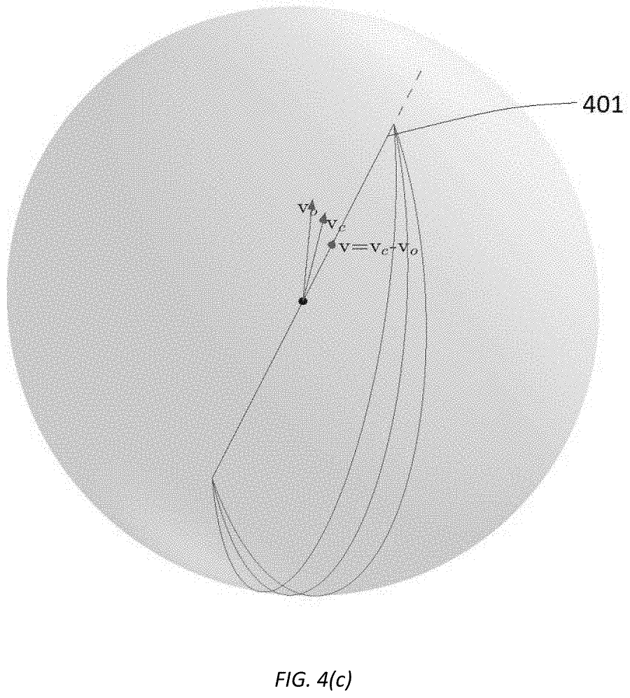

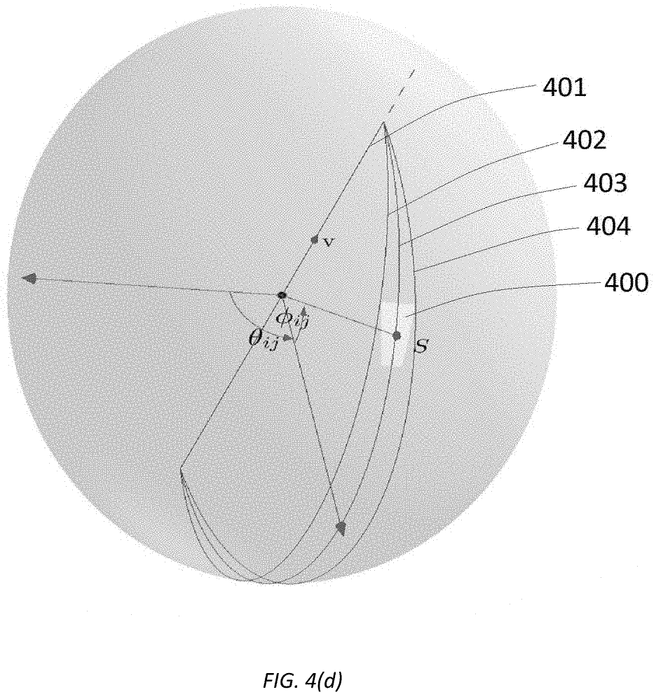

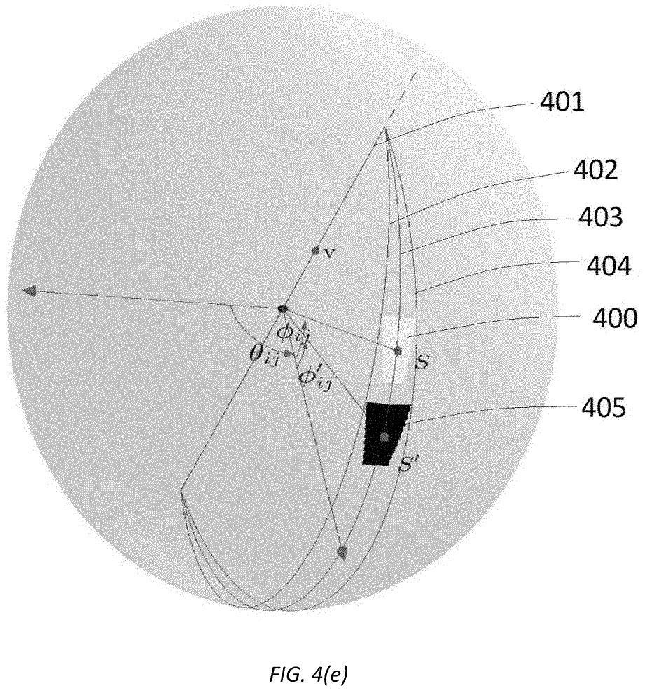

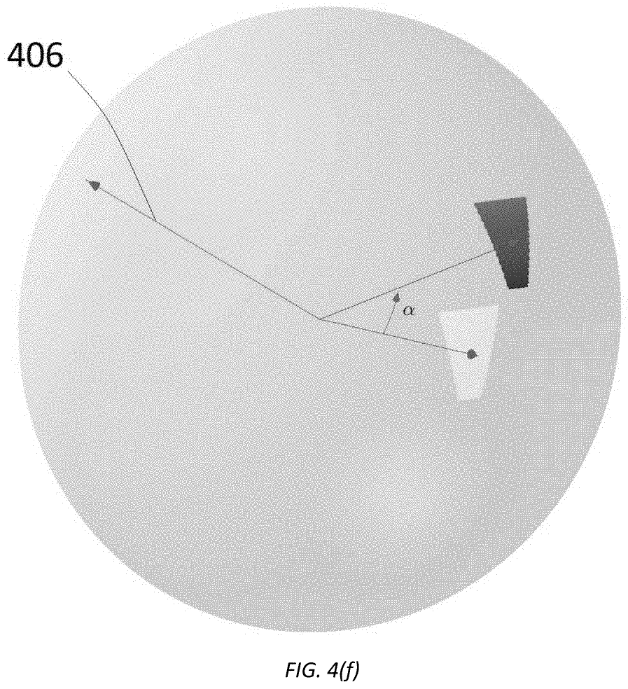

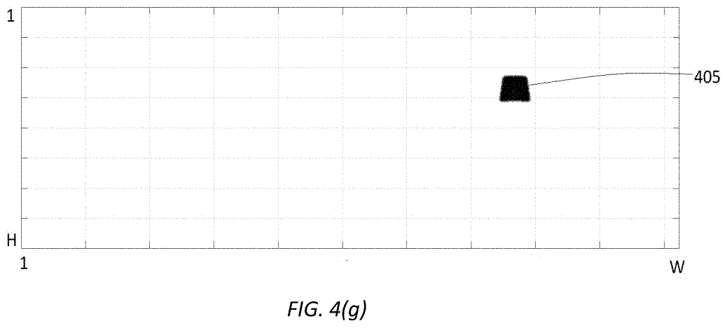

The above analysis provides valuable insights into the perceived motion of objects on the sphere, and implies that it can be effectively captured in terms of translation of pixels along their respective geodesics. These geodesics are determined by the two intersection points where a line that depends on the camera and object velocity vectors intersects the sphere. Thus the present invention performs motion compensation on the sphere, where it capture the true nature of perceived object motion, in contrast to standard techniques that perform motion compensation in the projected plane where motion is warped and lacks precise physical meaning. The overall paradigm for the motion compensated prediction consists of several steps, each employed in one or more embodiments of the invention, as illustrated in FIGS. 4(a)-4(g), wherein FIG. 4(a) shows a block 400 in a current ERP frame with height H and width W. FIG. 4(b) depicts line 401 along vector v, and the relevant geodesics it determines for the case of camera translation and static objects (in this case v is the same as the camera velocity, v=v_{c}). FIG. 4(c) depicts line 401 along vector v, and the relevant geodesics it determines for the case of camera translation and object motion (in this case v is the camera velocity relative to the object, v=v_{c}−vₒ). FIG. 4(d) depicts the block 400 after mapping to a sphere. The present invention defines geodesics that all intersect at the point where the line 401 along the vector determined by the velocity vectors of the camera and the object intersects the sphere. Three example geodesics are enumerated 402, 403, 404 in FIG. 4(d). In FIG. 4(e) each pixel in the block 400 is translated along its respective geodesic to obtain the motion-compensated block 405. FIG. 4(f) depicts a block rotation operation about axis 406, which complements geodesic translation in one or more embodiments of the invention. FIG. 4(g) shows the block 405 after mapping back to the ERP domain.

Consider a portion of the current frame, typically a block of pixels, in the projected domain, which is to be predicted from the reference frame. As noted above, an example of such a block 400 in the ERP domain is illustrated in FIG. 4(a). The block 400 of pixels in the current frame is mapped to the sphere using the inverse projection mapping. The example block 400 in FIG. 4(a) after mapping to the sphere is illustrated in FIG. 4(b).

One or more embodiments of the present invention employ spherical co-ordinates that are defined with respect to the line 401 determined by the camera and the object motions. In the case of static objects, the line 401 is along the direction of the camera velocity vector ‘v_{c}’ as illustrated in FIG. 4(b). In cases further involving a moving object with velocity ‘vₒ’, the line is along the direction of the difference vector v_{c}−vₒ as illustrated in FIG. 4(c). For a pixel (i,j) in the current block, the corresponding spherical coordinates with respect to line 401 is defined as (θᵢⱼ, ᵢⱼ) and is depicted in FIG. 4(d).

### 2. Geodesic Translation of the Block

The following governs how the video codec's motion vector side information is employed by one or more embodiments of the present invention. Given a motion vector (m, n), the first component is used to specify the change in azimuth and the second component ‘n’ is used to specify the change in elevation, wherein azimuth and elevation are defined with respect to line 401, which is determined by the physical motion of the camera and the object. A pixel with spherical coordinate (θᵢⱼ, φᵢⱼ) will be motion compensated to a point whose spherical coordinates (θ′ᵢⱼ, φ′ᵢⱼ) are given by:

θ′ᵢⱼ=θᵢⱼ+mΔθ

φ′ᵢⱼ=φᵢⱼ+nΔφ

FIG. 4(e) depicts the block 400 after geodesic translation to a block 405, assuming no change in azimuth i.e., m=0. The new spherical coordinates (θᵢⱼ, φ′ᵢⱼ) for a pixel (i,j) after geodesic translation are also depicted in FIG. 4(e).

In another embodiment of the present invention, the motion compensation further comprises a step of rotating a block about an axis 406 by an angle ‘a’ as illustrated in FIG. 4(f). This step captures the effects of camera rotation when the axis 406 coincides with the axis of camera rotation. In another scenario, the axis of rotation 406 coincides with line 401 which was determined by the camera and object velocity vectors, in which case the rotation allows for azimuth correction. The block of pixels after the above motion compensation on the sphere is mapped to the reference frame in the projected domain (following the projection format of choice). An illustration of block 405 mapped back to the ERP domain is shown in FIG. 4(g). Since the projected location might not be on the sampling grid of the reference frame, interpolation is performed in the reference frame to obtain the pixel value at the projected coordinate.

A preferred embodiment of this invention for motion compensation is summarized in the algorithm below.

1. Map the block of pixels in the current coding unit on to the sphere.

2. Calculate spherical coordinates with respect to the line 401, as determined by the camera and object velocity vectors.

3. Identify the geodesics that intersect at the point where the line 401 intersects the sphere.

4. Translate pixels in the block along the geodesics identified in Step 3 and, in one or more embodiments, further perform rotation about line 406.

5. After motion compensation on the sphere map the pixels to the reference frame in the projected geometry.

6. Perform interpolation in the reference frame to obtain the required predicted values.

### 3. Experimental Results

To obtain experimental results, the preferred embodiment of this invention was implemented in HM-16.14 [14]. The geometry mappings were performed using the projection conversion tool of [15]. Results are provided for the Random-Access profile in HEVC. The Lanczos 2 filter was used at the projected coordinate for interpolation in the reference frame. Also sphere padding was employed [16] in the reference frame for improved prediction along the frame edges for all the competing methods. The step size Δφ and Δθ was chosen to be π/H for ERP. For EAC, since each face has field of view of π/2, Δθ and Δφ were chosen to be λ/2W, where W is the width of each face.

30 frames of five 360-video sequences were encoded over four QP values of 22, 27, 32 and 37 in both ERP and EAC. All the sequences in ERP were at 2K resolution and the sequences in EAC had a face-width of 512. The distortion was measured in terms of Weighted-Spherical PSNR as advocated in [17]. Bitrate reduction was calculated as per [18]. The preferred embodiment of this invention provided significant overall bitrate reduction of about 23% on average for ERP and of about 6% on average for EAC.

### 4. Coding and Decoding System

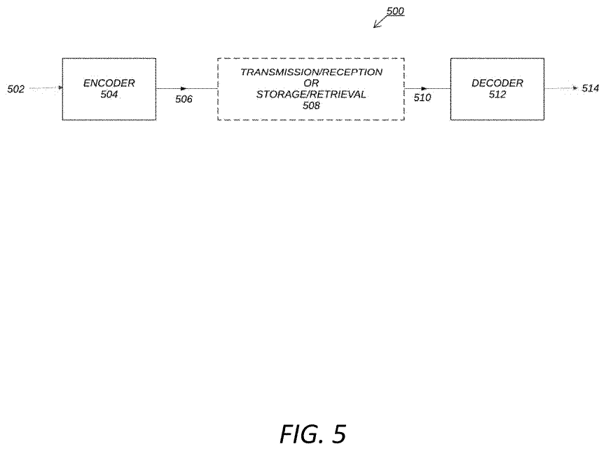

FIG. 5 is a schematic diagram illustrating an exemplary embodiment of a multimedia coding and decoding (codec) system 500 according to one embodiment of the present invention. The codec 500 accepts a signal 502 comprising the multimedia data stream as input, which is then processed by an encoder 504 to generate encoded data 506. The encoded data 506 can be used for transmission/reception or storage/retrieval at 508. Thereafter, the encoded data 510 can be processed by a decoder 512, using the inverse of the functions performed by the encoder 504, to reconstruct the multimedia data stream, which is then output as a signal 514. Note that, depending on the implementation, the codec 500 may comprise an encoder 504, a decoder 512, or both an encoder 504 and a decoder 512.

### 5. Hardware Environment

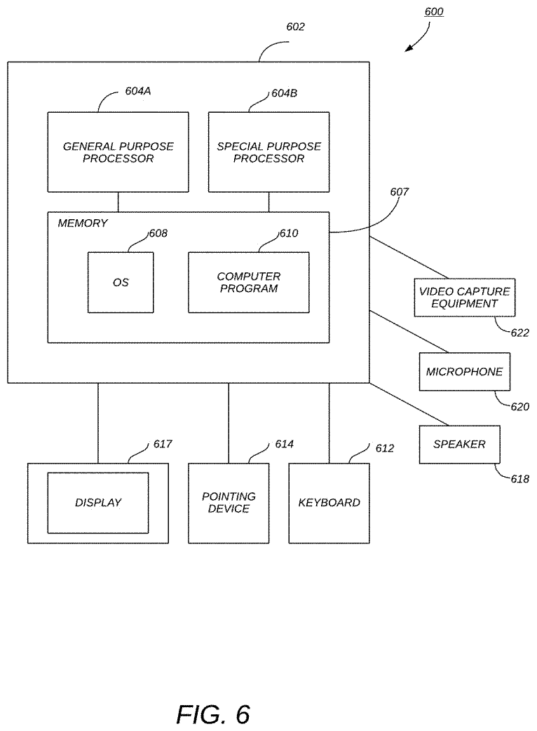

FIG. 6 is an exemplary hardware and software environment 600 that may be used to implement one or more components of the multimedia codec system 500, such as the encoder 604, the transmission/reception or storage/retrieval 508, and/or the decoder 512.

The hardware and software environment includes a computer 602 and may include peripherals. The computer 602 comprises a general purpose hardware processor 604A and/or a special purpose hardware processor 604B (hereinafter alternatively collectively referred to as processor 604) and a memory 607, such as random access memory (RAM). The computer 602 may be coupled to, and/or integrated with, other devices, including input/output (I/O) devices such as a keyboard 612 and a cursor control device 614 (e.g., a mouse, a pointing device, pen and tablet, touch screen, multi-touch device, etc.), a display 617, a speaker 618 (or multiple speakers or a headset), a microphone 620, and/or a video capture equipment 622 (such as a camera). In yet another embodiment, the computer 602 may comprise a multi-touch device, mobile phone, gaming system, internet enabled television, television set top box, multimedia content delivery server, or other internet enabled device executing on various platforms and operating systems.

In one embodiment, the computer 602 operates by the general purpose processor 604A performing instructions defined by the computer program 610 under control of an operating system 608. The computer program 610 and/or the operating system 608 may be stored in the memory 607 and may interface with the user and/or other devices to accept input and commands and, based on such input and commands and the instructions defined by the computer program 610 and operating system 608, to provide output and results.

Alternatively, some or all of the operations performed by the computer 602 according to the computer program 610 instructions may be implemented in a special purpose processor 604B, wherein some or all of the computer program 610 instructions may be implemented via firmware instructions stored in a read only memory (ROM), a programmable read only memory (PROM) or flash memory, or in memory 607. The special purpose processor 604B may also comprise an application specific integrated circuit (ASIC) or other dedicated hardware or circuitry.

The encoder 504, the transmission/reception or storage/retrieval 508, and/or the decoder 512, and any related components, may be performed within/by computer program 610 and/or may be executed by processors 604. Alternatively, or in addition, the encoder 504, the transmission/reception or storage/retrieval 508, and/or the decoder 512, and any related components, may be part of computer 602 or accessed via computer 602.

Output/results may be played back on video display 617 or provided to another device for playback or further processing or action.

Of course, those skilled in the art will recognize that any combination of the above components, or any number of different components, peripherals, and other devices, may be used with the computer 602.

### 6. Logical Flow

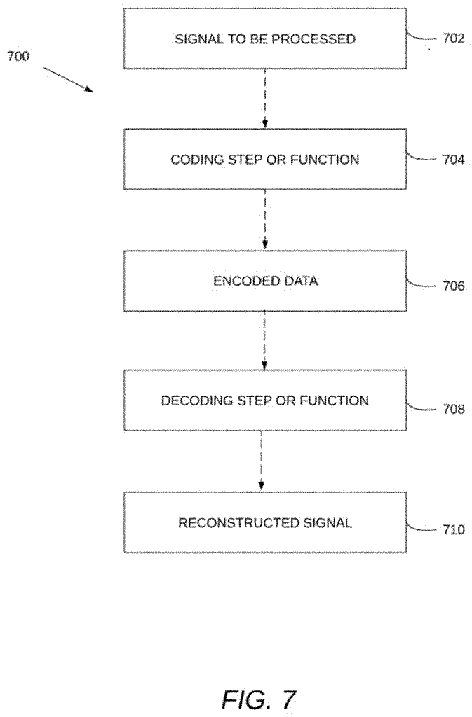

FIG. 7 illustrates the logical flow 700 for processing a signal in accordance with one or more embodiments of the invention. Note that all of these steps or functions may be performed by the multimedia codec system 500, or the multimedia codec system 500 may only perform a subset of the steps or functions. Thus, the multimedia codec system 500 may perform the compressing steps or functions, the decompressing steps or functions, or both the compressing and decompressing steps or functions.

Block 702 represents a signal to be processed (coded and/or decoded). The signal comprises a video data stream, or other multimedia data streams comprised of a plurality of frames.

Block 704 represents a coding step or function, which processes the signal in an encoder 504 to generate encoded data 706.

Block 708 represents a decoding step or function, which processes the encoded data 806 in a decoder 512 to generate a reconstructed multimedia data stream 710.

In one embodiment, the multimedia data stream contains a spherical video signal comprising visual information on a sphere that encloses a viewer, and the encoder 504 or the decoder 512 comprises a motion-compensated predictor, which predicts a portion of a current frame of the spherical video signal from a corresponding portion of one or more reference frames of the spherical video signal, after motion compensation, and the motion compensation comprises translating the pixels along geodesics on the sphere, where the geodesics are along shortest paths on the sphere from the pixels to two points where the sphere is intersected by a line determined by motion of the camera and surrounding objects. In another embodiment, the line determined by the motion of the camera and surrounding objects is along a velocity vector of the camera. In another embodiment, the line determined by the motion of the camera and surrounding objects is along a vector obtained by subtracting a velocity vector of one of the surrounding objects from the velocity vector of the camera. In another embodiment, the line determined by the motion of the camera and surrounding objects varies from one portion of the current frame to another portion of the current frame. In another embodiment, the motion compensation further comprises rotation of the pixels about an axis. In another embodiment, the line determined by the motion of the camera and surrounding objects varies from one portion of the current frame to another portion of the current frame. In another embodiment, the motion-compensated predictor further performs interpolation in the one or more reference frames to enable motion compensation at a sub-pixel resolution. In another embodiment, the encoded data 706 comprises information, which specifies for a portion of the current frame, a distance that pixels are to be translated along the geodesics on the sphere.

### REFERENCES

The following references are incorporated by reference herein to the description and specification of the present application.
[1] J. P. Snyder, Flattening the earth: two thousand years of map projections, University of Chicago Press, 1997.
[2] M. Zhou, “AHG8: A study on equi-angular cubemap projection,” Document JVET-G0056, 2017.
[3] Y. He, B. Vishwanath, X. Xiu, and Y. Ye, “AHG8: Algorithm description of Interdigital's projection format conversion tool (PCT360),” Document JVET-D0021, 2016.
[4] T. Wiegand, G. J. Sullivan, G. Bjøntegaard, and A. Luthra, “Overview of the H.264/AVC video coding standard,” IEEE Transactions on Circuits and Systems for Video Technology, vol. 13, no. 7, pp. 560-576, 2003.
[5] G. J. Sullivan, J. Ohm, W. Han, and T. Wiegand, “Overview of the high efficiency video coding (HEVC) standard,” IEEE Transactions on Circuits and Systems for Video Technology, vol. 22, no. 12, pp. 1649-1668, 2012.
[6] M. Narroschke and R. Swoboda, “Extending HEVC by an affine motion model,” in Picture Coding Symposium (PCS), 2013, pp. 321-324.
[7] H. Huang, J. W. Woods, Y. Zhao, and H. Bai, “Control-point representation and differential coding affine-motion compensation,” IEEE Transactions on Circuits and Systems for Video Technology, vol. 23, no. 10, pp. 1651-1660, 2013.
[8] L. Li, Z. Li, M. Budagavi, and H. Li, “Projection based advanced motion model for cubic mapping for 360-degree video,” arXiv preprint arXiv:1702.06277, 2017.
[9] B. Vishwanath, T. Nanjundaswamy, and K. Rose, “Rotational motion model for temporal prediction in 360 video coding,” in IEEE International Workshop on Multimedia Signal Processing (MMSP), 2017.
[10] I. Tosic, I. Bogdanova, P. Frossard, and P. Vandergheynst, “Multiresolution motion estimation for omnidirectional images,” in 13th European Signal Processing Conference. IEEE, 2005, pp. 1-4.
[11] A. Ahmmed, M. M. Hannuksela, and M. Gabbouj, “Fisheye video coding using elastic motion compensated reference frames,” in IEEE International Conference on Image Processing (ICIP), 2016, pp. 2027-2031.
[12] G. Jin, A. Saxena, and M. Budagavi, “Motion estimation and compensation for fisheye warped video,” in IEEE International Conference on Image Processing (ICIP), 2015, pp. 2751-2755.
[13] J. Boyce and Q. Xu, “Spherical rotation orientation indication for hevc and jem coding of 360 degree video,” in Applications of Digital Image Processing XL. International Society for Optics and Photonics, 2017, vol. 10396, p. 1039601.
[14] “High efficiency video coding test model, HM-16.14,” https://hevc.hhi.fraunhofer.de/svn/svn HEVCSoftware/tags/, 2016.
[15] Y. He, B. Vishwanath, X. Xiu, and Y. Ye, “AHG8: Interdigital's projection format conversion tool,” Document JVET-D0021, 2016.
[16] Y. He, Y. Ye, P. Hanhart, and X. Xiu, “AHG8: Geometry padding for 360 video coding,” Document JVET-D0075, 2016.
[17] Y. Sun, A. Lu, and L. Yu, “AHG8: WS-PSNR for 360 video objective quality evaluation,” Document JVET-D0040, 2016.
[18] G. Bjontegaard, “Calculation of average psnr differences between rd-curves,” Doc. VCEG-M33 ITU-T Q6/16, Austin, Tex., USA, 2-4 Apr. 2001.

### CONCLUSION

In conclusion, embodiments of the present invention provide an efficient and effective solution for motion compensated prediction of spherical video dominated by camera motion. The solution involves a per-pixel geodesic translation motion model that perfectly captures the perceived motion of objects on sphere due to physical motions of camera and object, as well as the resulting perspective distortions. The effectiveness of such an approach has been demonstrated for different projection formats with HEVC based coding.

Accordingly, embodiments of the invention enable performance improvement in various multimedia related applications, including for example, multimedia storage and distribution (e.g., YouTube™, Facebook™, Microsoft™). Further embodiments may also be utilized in multimedia applications that involve spherical video.

In view of the above, embodiments of the present invention disclose methods and devices for motion compensated prediction of spherical video and particularly in cases where the dynamics are dominated by camera motion.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the invention and the following claims, and the full range of equivalents of the claims.

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto and the full range of equivalents of the claims. The attached claims are presented merely as one aspect of the present invention. The Applicant does not disclaim any claim scope of the present invention through the inclusion of this or any other claim language that is presented or may be presented in the future. Any disclaimers, expressed or implied, made during prosecution of the present application regarding these or other changes are hereby rescinded for at least the reason of recapturing any potential disclaimed claim scope affected by these changes during prosecution of this and any related applications. Applicant reserves the right to file broader claims in one or more continuation or divisional applications in accordance within the full breadth of disclosure, and the full range of doctrine of equivalents of the disclosure, as recited in the original specification.

What is claimed is:

1. An apparatus for processing a multimedia data stream, comprising:
a codec for processing a multimedia data stream comprised of a plurality of frames, wherein the codec comprises an encoder, a decoder, or both an encoder and a decoder;
the encoder processes the multimedia data stream to generate encoded data and the decoder processes the encoded data to reconstruct the multimedia data stream;
the multimedia data stream contains a spherical video signal comprising visual information on a sphere that encloses a viewer;
the encoder or the decoder comprises a motion-compensated predictor, which predicts pixels in a portion of a current frame of the spherical video signal from pixels in a corresponding portion of one or more reference frames of the spherical video signal, after motion compensation;
and the motion compensation comprises translating pixels along geodesics on the sphere, where the geodesics are along shortest paths on the sphere from the pixels to two points where the sphere is intersected by a line determined by motion of the camera and surrounding objects.

2. The apparatus of claim 1, wherein the line determined by the motion of the camera and surrounding objects is along a velocity vector of the camera.

3. The apparatus of claim 1, wherein the line determined by the motion of the camera and surrounding objects is along a vector obtained by subtracting a velocity vector of one of the surrounding objects from a velocity vector of the camera.

4. The apparatus of claim 1, wherein the line determined by the motion of the camera and surrounding objects varies from one portion of the current frame to another portion of the current frame.

5. The apparatus of claim 1, wherein the motion compensation further comprises rotation of pixels about an axis.

6. The apparatus of claim 5, wherein the axis coincides with the line determined by the motion of the camera and surrounding objects.

7. The apparatus of claim 5, wherein the axis coincides with an axis of rotation of the camera.

8. The apparatus of claim 1, wherein the motion-compensated predictor further performs interpolation in the one or more reference frames to enable the motion compensation at a sub-pixel resolution.

9. The apparatus of claim 1, wherein the encoded data comprises information that specifies, for a portion of the current frame, a distance that pixels are to be translated along the geodesics on the sphere.

10. A method for processing a multimedia data stream, comprising:
processing a multimedia data stream comprised of a plurality of frames in a codec, wherein the codec comprises an encoder, a decoder, or both an encoder and a decoder;
the encoder processes the multimedia data stream to generate encoded data and the decoder processes the encoded data to reconstruct the multimedia data stream;
the multimedia data stream contains a spherical video signal comprising visual information on a sphere that encloses a viewer;
the processing in the codec comprises motion-compensated prediction, wherein pixels in a portion of a current frame of the spherical video signal are predicted from pixels in a corresponding portion of one or more reference frames of the spherical video signal, after motion compensation;
and the motion compensation comprises translating pixels along geodesics on the sphere, where the geodesics are along shortest paths on the sphere from the pixels to two points where the sphere is intersected by a line determined by motion of the camera and surrounding objects.

11. The method of claim 10, wherein the line determined by the motion of the camera and surrounding objects is along a velocity vector of the camera.

12. The method of claim 10, wherein the line determined by the motion of the camera and surrounding objects is along a vector obtained by subtracting a velocity vector of one of the surrounding objects from a velocity vector of the camera.

13. The method of claim 10, wherein the line determined by the motion of the camera and surrounding objects varies from one portion of the current frame to another portion of the current frame.

14. The method of claim 10, wherein the motion compensation further comprises rotation of pixels about an axis.

15. The method of claim 14, wherein the axis coincides with the line determined by the motion of the camera and surrounding objects.

16. The method of claim 14, wherein the axis coincides with an axis of rotation of the camera.

17. The method of claim 10, wherein the motion-compensated prediction further comprises interpolation in the one or more reference frames to enable the motion compensation at a sub-pixel resolution.

18. The method of claim 10, wherein the encoded data comprises information that specifies, for a portion of the current frame, a distance that pixels are to be translated along the geodesics on the sphere.
